(19) United States
(12) Patent Application Publication
(10) Pub. No.: US 2026/0153195 A1
(43) Pub. Date: Jun. 4, 2026

(54) GAS STORAGE CONTAINER

(71) Applicant: Atomis Inc., Kobe-shi (JP)

(72) Inventor: Daisuke ASARI, Kyoto-shi (JP)

(21) Appl. No.: 18/575,316

(22) PCT Filed: Jun. 30, 2022
(86) PCT No.: PCT/JP2022/026225

§ 371 Date: Dec. 29, 2023

(30) Foreign Application Priority Data
Jun. 30, 2021 (JP) 2021-108445

(51) Int. Cl. F17C 13/00

(52) U.S. Cl. CPC F17C 13/003; F17C 2201/0104; F17C 2203/0692; F17C 2205/0111; F17C 2205/0169; F17C 2250/0408

(57) ABSTRACT

The present invention makes it possible to provide a configuration for a gas storage container including a casing and a gas container, in which information regarding the gas container can be efficiently acquired without the need for removing the casing or checking with an external device. The gas storage container according to the present invention includes a casing that has a flat upper surface and a flat lower surface and is vertically stackable, and a gas container installed in the casing. The casing has at least one window for making the gas container visible from the outside.

### CROSS-REFERENCE TO RELATED APPLICATIONS

The present application is a national stage application, filed under 35 U.S.C. § 371, of international Patent Application No. PCT/JP 2022/026225 filed Jun. 30, 2022, and the disclosure of which is incorporated herein by reference in its entirety.

### FIELD OF THE INVENTION

The present disclosure relates to a gas storage container that includes a casing and a gas container.

### BACKGROUND OF THE INVENTION

Gas cylinders having a large weight and a bottle shape have been generally used. However, such gas cylinders are not easy to handle as they have large occupied volume and are difficult to transport and install. Also, such gas cylinders are not meant to have aesthetic appearances.

Therefore, with the aim of providing a gas storage container that is easy to transport and install, the Applicant has reported a gas storage container that has flat upper and lower surfaces and is vertically stackable (Patent Document 1). As one variation, this document discloses a gas storage container including a casing with a flat upper surface and a flat lower surface and is vertically stackable, and a gas container installed in the casing (claim 9). Further, this document also discloses a configuration further including a gas remaining amount measurement module (claim 10).

### CITATION LIST

### Patent Literature

[Patent Document 1] WO2019/026872

### SUMMARY OF THE INVENTION

### Technical Problem

However, the present inventor has found a new problem that in the above configuration, once the gas container is housed in the casing, it is difficult to obtain information about the gas container unless the casing is removed or the information displayed on the monitoring terminal or the like is checked via the gas remaining amount measurement module. Even when the information such as the type of gas was affixed to the casing with a seal, etc., it was still difficult to efficiently confirm whether the indication of the type of gas on the casing was indeed consistent with the type of gas actually contained in the gas container. This challenge can be particularly problematic in checking operations, for example, when preparing gas storage containers at an administrator and when transporting gas storage containers from the administrator to a user.

Accordingly, it is an object of the present invention to provide a configuration for a gas storage container including a casing and a gas container, in which information regarding the gas container can be efficiently acquired without the need for removing the casing or checking with an external device.

### Solution to Problem

According to an exemplary embodiment of the present invention, a gas storage container is provided as below.
[1] A gas storage container, comprising: a casing with a flat upper surface and a flat lower surface and is vertically stackable; and a gas container installed in the casing, wherein the casing has at least one window for making the gas container visible from outside.
[2] The gas storage container according to [1], wherein the window comprises a transparent or translucent member.
[3] The gas storage container according to [1] or [2], wherein one of the upper surface and the lower surface is provided with a protrusion, and the other of the upper surface and the lower surface is provided with a recess corresponding to the protrusion.
[4] The gas storage container according to any one of [1] to [3], wherein the casing has a plurality of side surfaces, and at least one of the side surfaces is provided with a protrusion, and the other side surface opposite to the one of the side surfaces is provided with a recess corresponding to the protrusion.
[5] The gas storage container according to [3] or [4], wherein the window is provided in at least one location selecting from one or more of the protrusions and one or more of the recesses.
[6] The gas storage container according to any one of [1] to [5], further comprising a gas remaining amount measurement module.
[7] The gas storage container according to [6], wherein at least a part of the gas remaining amount measurement module is installed in a space between the casing and the gas container.
[8] The gas storage container according to [7], at least a part of the gas remaining amount measuring module is installed so as not to be visible through the window.
[9] The gas storage container according to any one of [1] to [8], further comprising a porous material in the gas container.
[10] The gas storage container according to [9], wherein the porous material is a Metal Organic Framework (MOF).

### Advantageous Effects of Invention

The present invention makes it possible to realize a configuration for a gas storage container including a casing and a gas container, in which information regarding the gas container can be efficiently acquired without the need for removing the casing or checking with an external device.

### BRIEF DESCRIPTION OF THE DRAWINGS

FIG. 1 is a perspective view of a gas storage container according to one embodiment of the present invention as viewed from the top.

FIG. 2 is a perspective view of a gas storage container according to one embodiment of the present invention as viewed from the bottom.

FIG. 3 is a perspective view of a gas storage container according to one embodiment of the present invention as viewed from the back.

FIG. 4 is a conceptual diagram illustrating an example of a configuration of a gas remaining amount measurement module.

FIG. 5 is an exploded view of the gas storage container according to one embodiment of the present invention, showing a state where a part of the casing and the gas container are removed. FIG. 5 shows an example of a specific arrangement of the gas remaining amount measurement module.

### DETAILED DESCRIPTION

Some examples of a gas storage container according to the present invention are described below. When referring to the drawings, the same reference numerals are given to the components exhibiting the same or similar functions, and duplicate description will be omitted.

The gas storage container according to the present invention includes a casing that has a flat upper surface and a flat lower surface and is vertically stackable, and a gas container installed in the casing. The casing has at least one window for making the gas container visible from the outside.

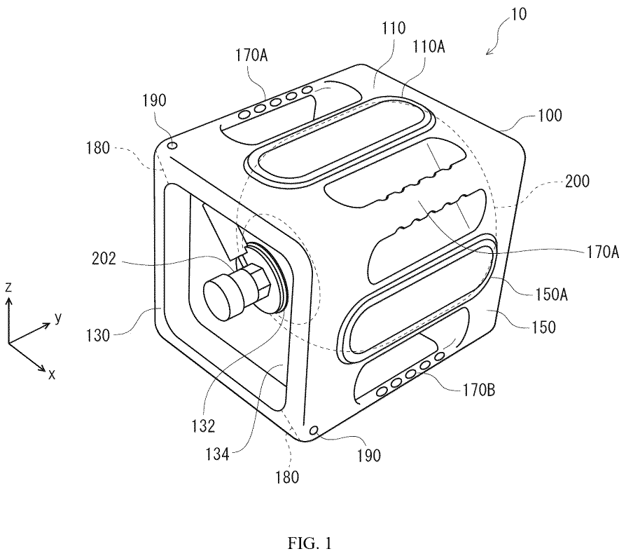

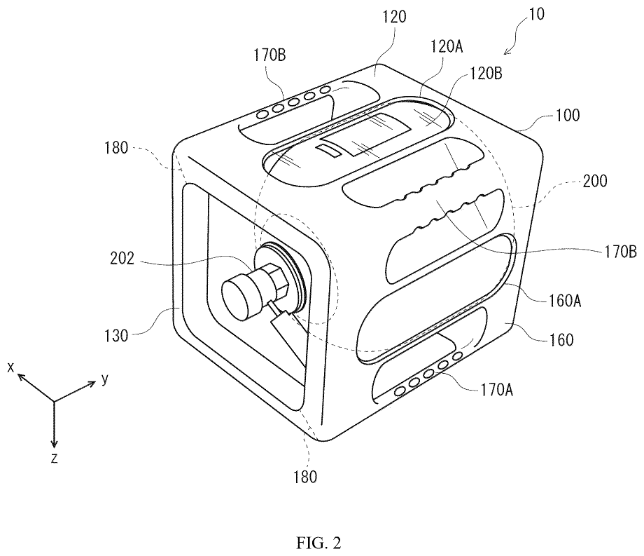

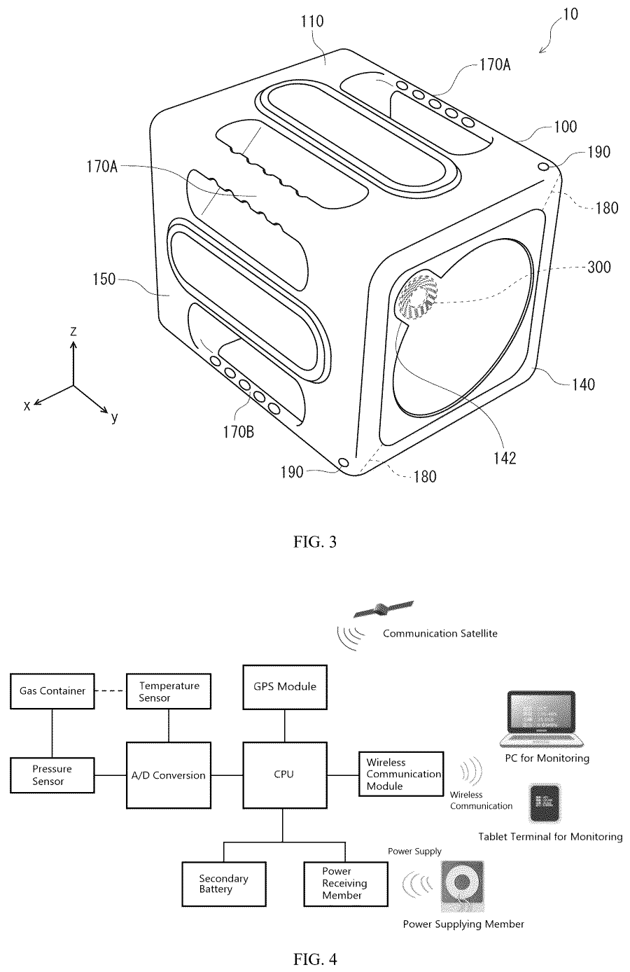

FIG. 1 is a perspective view of a gas storage container according to one embodiment of the present invention as viewed from the top. FIG. 2 is a perspective view of a gas storage container according to one embodiment of the present invention as viewed from the bottom. FIG. 3 is a perspective view of a gas storage container according to one embodiment of the present invention as viewed from the back. The gas storage container 10 shown in FIGS. 1 to 3 includes a casing 100, a gas container 200, and a gas remaining amount measurement module 300.

In this embodiment, casing 100 is substantially rectangular in shape and includes an upper surface 110, a lower surface 120, a front surface 130, a back surface 140, a right side surface 150, and a left side surface 160. That is, the casing 100 has an upper surface 110, a lower surface 120, and four side surfaces 130 to 160. Note that the expressions such as “upper surface”, “lower surface”, “front surface”, “back surface”, “right side surface”, “left side surface”, and “side surface” are only relative and do not limit the actual usage of the gas storage container 10. For example, it is also possible to use the gas storage container 10 with the “front surface” facing upward.

The upper surface 110 and the lower surface 120 are substantially flat. Thereby, the casings 100 can be stacked vertically. Adopting such a configuration makes it possible to easily and effectively transport and install the gas storage container.

The upper surface 110 includes a protrusion (a convex portion) 110A. The lower surface 120 includes a recess (a concave portion) 120A having a shape corresponding to the protrusion 110A. Typically, the protrusion 110A is configured to fit into the recess 120A. By employing such a configuration, it becomes possible to stack the casings 100 in the vertical direction more stably. The protrusion 110A and the recess 120A may be omitted. Note that when the protrusion and the recess “fit” here, it is not necessary for them to be physically fixed to each other, but it is sufficient if the shapes of both are spatially fitted to each other

In this embodiment, the recess 120A provided on the lower surface 120 comprises a window 120B for making the gas container 200 visible from the outside. In the example shown in FIG. 2, the label attached to the gas container 200 can be visually recognized through the window 120B. By adopting such a configuration, it becomes possible to efficiently acquire information regarding the gas container 200 without the need for removing the casing 100 or checking the gas remaining amount measurement module 300 using an electronic device.

The window 120B is typically transparent or translucent, preferably transparent, and more preferably colorless and transparent. The window 120B may be hollow or may include a transparent or translucent member. In the latter case, the material of the transparent or translucent member that may be fitted into the window 120B is, for example, plastic or glass, preferably plastic. When the window 120B includes a transparent or translucent member, it is possible to minimize the decrease in the strength of the casing 100 due to the provision of the window 120B.

The front surface 130 is substantially flat and includes a hole 132. The hole 132 has the role of exposing an outlet 202 of the gas container 200 to the outside. The hole 132 may be provided on a surface other than the front surface 130. Placing the hole 132 on at least one side surface rather than on the upper surface 110 or the lower surface 120 allows the gas storage containers 10 to be stacked one above the other even when the outlet 202 is equipped with a valve and/or regulator.

The front surface 130 further includes a dent 134 to prevent the outlet 202 from protruding from the outer surface of the casing 100. By adopting such a configuration, the occupied volume per piece can be reduced when carrying the gas storage containers 10. The outlet 202 is typically equipped with a valve. Additionally, when the gas storage container 10 is in use, a regulator (not shown) is typically attached to the valve. The dent 134 provided on the front surface 130 is typically constructed so that the outlet 202 does not protrude from the outer surface of the casing 100 when the outlet 202 is fitted with a valve but not a regulator. The dent 134 may be omitted.

The back surface 140 is substantially flat and is opposed to the front surface 130. Inside the casing 100 near the back surface 140 of the gas storage container 10, a power receiving member of the gas remaining amount measurement module 300 is installed. A recess 142 is provided on the back surface 140 at a position corresponding to the power receiving member of the gas remaining amount measurement module 300. The configuration of the gas remaining amount measurement module 300 will be explained in detail later. The recess 142 may be omitted.

The right side surface 150 is substantially flat. The right side surface 150 is provided with a protrusion 150A. The shape of the protrusion 150A is typically the same as the shape of the protrusion 110A. The protrusion 150A may be omitted.

The left side surface 160 is substantially flat and is opposed to the right side surface 150. The left side surface 160 is provided with a recess 160A. The shape of the recess 160A is typically the same as the shape of the recess 120A, except that it does not include the window 120B. That is, the recess 160A has a shape corresponding to the protrusion 150A. By employing such a configuration, it becomes possible to efficiently arrange the casings 100 in the lateral direction as well. The recess 160A may be omitted.

The casing 100 has a first grip 170A on the outer edge between the upper surface 110 and the right side surface 150. The casing 100 also has a first grip 170A on the outer edge between the upper surface 110 and the left side surface 160. Adopting such a configuration makes it easier for a user to transport and secure the gas storage container 10. Furthermore, when the grip(s) is formed by providing a hollow part on the outer edge as shown in FIGS. 1 to 3, it is possible to yet reduce the weight of the gas storage container 10. The first grip(s) 170A may be omitted.

The casing 100 has a second grip 170B on the outer edge between the lower surface 120 and the right side surface 150. The casing 100 also has a second grip 170B on the outer edge between the lower surface 120 and the left side surface 160. Adopting such a configuration makes it easier for a user to transport and secure the gas storage container 10. Also, when the grip(s) is formed by providing a hollow part on the outer edge as shown in FIGS. 1 to 3, it is possible to further reduce the weight of the gas storage container 10. The second grip(s) 170B may be omitted.

The casing 100 is configured to be able to be divided into two parts along a diagonal connecting surface 180. In the example shown in FIGS. 1 to 3, one portion includes the upper surface 110, the right side surface 150, a half of the front surface 130, and a half of the back surface 140. The other portion includes a lower surface 120, a left side surface 160, the remaining half of the front surface 130, and the remaining half of the back surface 140. These two parts are joined by screws (not shown) through screw holes 190. At this time, the casing 100 can be prevented from being easily disassembled by the user by forming the screw tool hole into a special shape. The connecting surface 180 and the screw hole 190 may be omitted.

The parts constituting the casing 100 may be joined by other methods. If the casing 100 is configured to be divisible, the casing 100 can be replaced relatively easily by an administrator of the gas storage container 10. There is no restriction on the method of dividing the casing 100.

The material of the casing 100 is not particularly limited and can be appropriately selected depending on the required strength, desired weight, ease of forming, degree of electrical interference during the contactless power supply, and the like. The material of the casing 100 is, for example, plastic, fiber-reinforced plastic, metal, or an alloy, preferably plastic or fiber-reinforced plastic.

In the configuration shown in FIGS. 1 to 3, a window 120B is provided in the recess 120A, but there are no particular restrictions on the position of such a window as long as the function of making the gas container 200 visible from the outside can be ensured. For example, the window may be provided in at least one of the other protrusions and/or recesses mentioned above. Alternatively, the window may be provided in a portion of the casing 100 other than the protrusions and/or the recesses. A plurality of windows may be provided at multiple locations on the casing 100. In addition, when providing a window in one of a protrusion and a recess, it is more preferable to provide a window in a recess from a viewpoint of the mechanical strength and breakage possibility of the window.

In the configurations shown in FIGS. 1 to 3, the casing 100 has a rectangular parallelepiped shape, but the shape of the casing 100 is not particularly limited as long as it satisfies the above requirements regarding the upper and lower surfaces. The casing 100 has, for example, a cylindrical shape or a prismatic shape, preferably a quadrangular prism, a pentagonal prism, or a hexagonal prism shape, and more preferably a quadrangular prism or a hexagonal prism shape. When the casing 100 has a prismatic shape, it is preferable that the casing 100 has a regular polygonal column shape. The casing 100 is more preferably rectangular or cubic in shape, especially preferably rectangular.

Furthermore, in the configurations shown in FIGS. 1 to 3, all of the plurality of side surfaces 130 to 160 are substantially flat. In this case, since a plurality of gas storage containers 10 can be efficiently arranged, the effective volume occupied during transportation and use can be particularly reduced. However, the plurality of side surfaces 130 to 160 do not necessarily have to be flat. For example, in a four-sided configuration as shown in FIGS. 1-3, it is possible to employ a configuration in which the front surface 130 and back surface 140 are not flat, but the right side surface 150 and left side surface 160 are substantially flat.

In the configuration shown in FIGS. 1 to 3, the upper surface 110 includes a protrusion 110A, and the lower surface 120 includes a recess 120A corresponding to the protrusion 110A, but there is no particular restriction on the configuration of these protrusions and recesses. For example, the upper surface 110 may include a recess, and the lower surface may include a protrusion corresponding to the recess. The shapes of the protrusion and the recess are also not particularly limited as long as the pairs provided at corresponding locations correspond to one another. These protrusions and recesses may be omitted.

In the configuration shown in FIGS. 1 to 3, the right side surface 150 includes a protrusion 150A, and the left side surface 160 opposing to it includes a recess 160A corresponding to the protrusion 150A, but there is no particular restriction on the configuration of these protrusions and recesses. For example, the right side surface 150 may include a recess, and the left side surface 160 may include a protrusion corresponding to the recess. The shapes of the protrusion and the recess are also not particularly limited as long as the pairs provided at corresponding locations correspond to one another. These protrusions and recesses may be omitted.

In the configuration shown in FIGS. 1 to 3, the first grip 170A and the second grip 170B are provided, but there is no particular restriction on the configuration of the grip parts. The grip(s) may be provided at other locations on the casing 100. However, as described above, if the grip(s) is formed by providing a hollow part on the outer edge of the casing 100, it becomes possible to more effectively utilize the part of the casing 100 that does not include the gas container 200 (i.e. the dead zone). The grip(s) may be omitted.

In the embodiment shown in FIGS. 1 to 3, the gas container 200 is installed inside the casing 100. In FIGS. 1 and 2, parts of the gas container 200 that are not visible from the outside are drawn with broken lines. Similarly, in FIGS. 1 and 2, the portion of the gas container 200 that is visible from the outside is drawn with a solid line. In FIG. 3, the illustration of the gas container 200 is omitted.

The gas container 200 includes a gas outlet 202. The gas outlet 202 usually also serves as a gas inlet. The outlet 202 is exposed to the outside through the hole 132 of the casing 100.

The gas container 200 typically has a rounded shape. By adopting such a configuration, the pressure resistance performance of the gas container 200 can be optimized. The gas containers 200 themselves cannot normally be stacked on top of each other. However, since the gas containers 200 are housed within the casing 100, the gas storage containers 10 can be stacked regardless of the shape of the gas containers 200.

Any material can be used for the gas container 200. The gas container 200 is, for example, made of fiber-reinforced plastic, metal or alloy, or comprises fiber-reinforced plastic and metal or alloy. Alternatively, the gas container 200 may be made of duralumin. The material used for the gas container 200 can be appropriately selected in consideration of formability and weight. The material of gas container 200 is typically different than the material of casing 100. Therefore, it is possible to adjust the strength, weight, pressure resistance, appearance, and the like of the entire gas storage container 10 by independently optimizing the material for the casing 100 and the material of the gas container 200.

There is no restriction in the kind of gas to be stored in the gas container 200. Examples of such gases include nitrogen; oxygen; air; carbon dioxide; rare gases such as helium, neon, argon, krypton, and xenon; hydrogen; saturated hydrocarbons such as methane, ethane, and propane; acetylene; fluorocarbons such as difluoromethane; LP gas; natural gas; monosilane; theos; dichlorosilane; arsine; phosphine; diborane; boron trichloride; carbon tetrafluoride; nitrogen trifluoride; hydrogen bromide; chlorine; tungsten hexafluoride; hydrogen selenide; monogermane; ethylene oxide; nitrous oxide; and ammonia. Among these, it is particularly preferable to use a gas selected from the group consisting of nitrogen, oxygen, air, argon, xenon, fluorocarbon, carbon dioxide, methane, and hydrogen. The gas stored in the gas container 200 may be liquefied.

The gas container 200 may further include a porous material therein. In such a case, the amount of gas stored in the gas container 200 can be increased. When filling the gas container 200 with a porous material, the filling rate F of the porous material is, for example, 60% or more, preferably 65% or more, and more preferably 70% or more. In such a case, the effect of increasing the amount of gas stored by filling the porous material becomes more remarkable. The upper limit of the filling rate is 100%, but the filling rate may be slightly lowered from the viewpoint of gas filling efficiency, exhaust heat, and the like. For example, the filling rate of the porous material may be 99% or less. Further, the filling rate may be further reduced in consideration of an increase in the weight of the gas storage container 10 due to the weight of the porous material itself.

As the porous material, for example, a metal organic framework (MOF), activated carbon, zeolite, mesoporous silica, or the like can be used. It is particularly preferable to use the MOF as the porous material. A plurality of types of porous materials may be used in combination.

When the MOF is employed as the porous material, any types of MOFs can be used. Appropriately combining the type and coordination number of the metal ion with the type and topology of the multidentate ligand leads to a MOF with a desired structure.

The metal elements in the MOF can be, for example, any elements belonging to alkali metals (Group 1), alkaline earth metals (Group 2), or transition metals (Groups 3 to 12). The multidentate ligand in the MOF typically is an organic ligand, examples of which include carboxylate anion and heterocyclic compound. Examples of the carboxylic acid anion include dicarboxylic acid anion and tricarboxylic acid anion. Specific examples include anions of citric acid, malic acid, terephthalic acid, isophthalic acid, trimesic acid, and derivatives thereof. Examples of the heterocyclic compound include bipyridine, imidazole, adenine, and derivatives thereof. Alternatively, the ligand may be an amine compound, a sulfonate anion, or a phosphate anion. The MOF may further contain monodentate ligand(s).

The combination of the metal and the ligand forming the MOF can be appropriately determined according to the expected function and the desired pore size. The MOF may contain two or more types of metal elements, and may contain two or more types of ligands. The MOF can be surface-modified with a polymer or other modifiers. Specific examples of the MOF include those listed in the Patent Document 1 above.

There is no restriction in the form of the porous material. As the porous material, for example, a powdery material, a pellet material, a bead material, a film material, or a block material may be used. A plurality of forms of porous materials may be used in combination.

As described above, the gas storage container 10 may further include a gas remaining amount measurement module 300. The gas remaining amount measurement module 300 typically includes at least one of a pressure sensor and a temperature sensor.

The gas remaining amount measurement module 300 is preferably configured to perform wireless communication. The gas remaining amount measurement module 300 may be configured to perform GPS communication. Adopting such a configuration makes it possible to remotely manage the gas remaining amount in the gas storage container 10.

The gas remaining amount measurement module 300 preferably includes a power receiving member for a contactless power supply. When such a configuration is adopted, the user can supply power to the gas remaining amount measurement module 300 using the power supplying member corresponding to the power receiving member. That is, by employing such a configuration, even if the electrical life of the gas remaining amount measurement module 300 has expired, the user does not need to return or replace the gas storage container 10 itself. Also, the administrator of the gas storage container 10 does not need to collect or replace the gas storage container 10 in such a case.

In the configuration shown in FIG. 3, the power receiving member of the gas remaining amount measurement module 300 is provided near the back surface 140 of the casing 100. That is, in this configuration, the power receiving member is provided on the surface opposing the side surface of the gas container 200 where the gas outlet 202 is exposed. When such a configuration is adopted, even when a plurality of gas storage containers 10 are stacked vertically and/or arranged in parallel on the left and right, the surface on the side where the power receiving member is located remains facing outside. Therefore, when such a configuration is adopted, it becomes possible to easily supply power to any gas storage container 10 even when a plurality of gas storage containers 10 are arranged vertically and/or horizontally.

Note that in this configuration, the power receiving member of the gas remaining amount measurement module 300 is provided inside the casing 100. That is, the power receiving member of the gas remaining amount measurement module 300 is provided between the casing 100 and the gas container 200 and is not exposed to the outside. If such a configuration is adopted, the possibility of failure of the power receiving member can be reduced. Furthermore, by configuring the power receiving member to be invisible from the outside, the overall aesthetic appearance of the gas storage container 10 can also be improved.

The power receiving member of the gas remaining amount measurement module 300 has a configuration that allows contactless power supply. Therefore, there is no need to further provide the gas storage container 10 with a cable port or the like for contact power supply. Therefore, with the above configuration, a decrease in strength of the gas storage container 10 and an increase in manufacturing cost can be suppressed compared to the case where a configuration for performing contact power supply is added thereto.

FIG. 4 is a conceptual diagram illustrating an example of a configuration of a gas remaining amount measurement module. The gas remaining amount measurement module shown in FIG. 4 is an Internet of Things (IOT) module, and includes a pressure sensor, a temperature sensor, an analog/digital (A/D) converter connected to both sensors, and a central processing unit (CPU) connected to the A/D converter.

The pressure sensor is typically connected to an outlet of a gas container constituting the gas storage container. The temperature sensor may be connected to the gas container or placed near the gas container. That is, the temperature sensor may be configured to measure the temperature inside the gas container, or may be configured to measure the temperature in the vicinity of the gas container. If liquefied gas can be stored in the gas container, a liquid level sensor may be used instead of the pressure sensor or in combination with the pressure sensor. As the liquid level sensor, for example, a float sensor, an ultrasonic sensor, or a capacitance sensor can be used. As described above, the gas remaining amount measurement module preferably includes at least one sensor selected from the group consisting of a pressure sensor, a liquid level sensor, and a temperature sensor.

The CPU is further connected to a wireless communication module configured to perform wireless communication and a GPS communication module configured to perform GPS communication. The wireless communication module is used, for example, to transmit measurement value data to a monitor PC or tablet etc. In the example shown in FIG. 4, information on temperature (25° C.), position (135.405 degrees east longitude/35.010 degrees north latitude), and pressure (9.85 MPa) is displayed on the monitor PC or tablet. For instance, a Bluetooth (registered trademark) communication module can be used as the wireless communication module. Using such a gas remaining amount measurement module makes it possible for the user to easily follow the remaining amount and position information of the gas storage container 10. This also facilitates inventory management and distribution management of the gas storage containers 10.

The gas remaining amount measurement module shown in FIG. 4 further includes the above-described power receiving member and a rechargeable battery (secondary battery). When such a configuration is adopted, the secondary battery can be charged by power feeding from a power supplying member to the power receiving member. This allows the user to charge the gas remaining amount measurement module, and allows the user to keep using the gas remaining amount measurement module for a long period of time.

There is no particular restriction on the configuration of the power receiving member. The power receiving member is typically a power receiving coil. The contactless power feeding from the power supplying member to the power receiving member may be of a non-radiation type (short distance type) or a radiation type (long distance type). Examples of non-radiative power feeding methods include methods using electromagnetic induction, magnetic field resonance, or electric field coupling. Examples of the radiation type power feeding method include a radio wave method and a laser method. In view of the transmissibility through the shielding material (i.e. casing 100), it is particularly preferable that the contactless power supply from the power supplying member to the power receiving member be performed by the electromagnetic induction method or the magnetic field resonance method. The power supply to the power receiving member can be performed, for example, via a specific pedestal. The power may be supplied to the power receiving member by any other method.

Note that the configuration shown in FIG. 4 is just an example. The configuration of the gas remaining amount measurement module is not particularly limited as long as it is capable of measuring the remaining amount of gas. That is, some of the components shown in FIG. 4 may be omitted as long as the above functions are ensured.

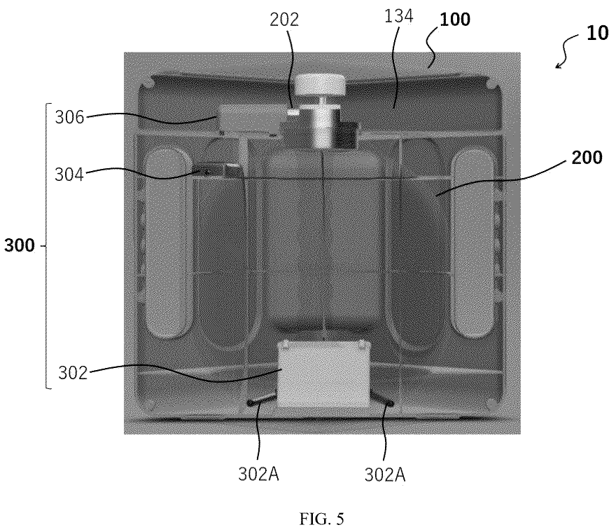

FIG. 5 is an exploded view of the gas storage container according to one embodiment of the present invention, showing a state where a part of the casing and the gas container are removed. FIG. 5 shows an example of a specific arrangement of the gas remaining amount measurement module 300.

In the example shown in FIG. 5, the gas remaining amount measurement module 300 includes an IoT box 302, a GPS module 304, and a pressure sensor 306. The IoT box 302, the GPS module 304, and the pressure sensor 306 are connected to each other by wire (not shown) or are connected wirelessly. Of the gas remaining amount measurement module 300, the IoT box 302 and the GPS module 304 are installed in a gap between the casing 100 and the gas container 200.

The IoT box 302 is installed near the back surface 140 of the casing 100. The IoT box 302 includes therein a power receiving member, a secondary battery, a wireless communication module, and a CPU. An antenna 302A for wireless communication extends outside the IoT box 302.

The wireless communication module 304 is provided separately outside the IoT box 302. By adopting such a configuration, for example, heat generation due to intensive use and electrical interference with other components can be minimized.

Pressure sensor 306 is connected to outlet 202 of gas container 200. Pressure sensor 306 is typically located within a dent 134 in front surface 130 of casing 100.

In the example shown in FIG. 5, the gas remaining amount measurement module 300 other than the pressure sensor 306 is provided between the casing 100 and the gas container 200. In this way, by adopting a configuration in which at least a portion of the gas remaining amount measurement module 300 is installed between the casing 100 and the gas container 200, the possibility of failure of the gas remaining amount measurement module 300 can be reduced. Further, by adopting such a configuration, it is also possible to prevent an increase in the volume occupied by the gas storage container 10 due to the addition of the gas remaining amount measurement module 300.

Here, it is preferable that at least a part of the gas remaining amount measurement module 300 is installed between the casing 100 and the gas container 200 so as not to be visible through the window 120B. By employing such a configuration, it is possible to reduce the possibility that the aesthetic appearance of the gas storage container 10 is impaired due to the presence of the gas remaining amount measurement module 300. Further, by employing such a configuration, it is possible to reduce the possibility that the gas remaining amount measurement module 300 will obstruct visual recognition of the gas container 200 from the outside.

As described above, the configuration of the gas remaining amount measurement module 300 shown in FIG. 5 is just an example. Each component of the gas remaining amount measurement module 300 shown in FIG. 5 may be arranged at other locations in the gas storage container 10. For example, the GPS module 304 may be installed inside the IoT box 302. Further, some of the components of the gas remaining amount measurement module 300 shown in FIG. 5 may be omitted as appropriate.

Gas storage container 10 is typically portable by human. The total weight of the gas storage container 10 is, for example, 30 kg or less, preferably 25 kg or less, more preferably 20 kg or less, particularly preferably 15 kg or less. Note that here, the total weight of the gas storage container 10 is the total weight of the casing 100, the gas container 200, and the gas remaining amount measurement module 300. This total weight does not include the weight of the gas filled into the gas container 200. However, if the gas container 200 further includes a porous material, the total weight shall also include the weight of the porous material.

This specification has described a configuration in which a gas storage container has a casing whose upper and lower surfaces are flat and can be stacked vertically, and a gas container installed in the casing, the casing having a window to make the gas container visible from outside. However, such a window may also be formed generically in casings of any shape. That is, such windows are also applicable to casings and gas storage containers of arbitrary shapes that are not stackable one above the other.

1. A gas storage container, comprising:
a casing with a flat upper surface and a flat lower surface and is vertically stackable; and
a gas container installed in the casing,
wherein
the casing has at least one window for making the gas container visible from outside.

2. The gas storage container according to claim 1, wherein
the window comprises a transparent or translucent member.

3. The gas storage container according to claim 1, wherein
one of the upper surface and the lower surface is provided with a protrusion, and the other of the upper surface and the lower surface is provided with a recess corresponding to the protrusion.

4. The gas storage container according to claim 1, wherein
the casing has a plurality of side surfaces, and at least one of the side surfaces is provided with a protrusion, and the other side surface opposite to the at least one of the side surfaces is provided with a recess corresponding to the protrusion.

5. The gas storage container according to claim 3, wherein
wherein the window is provided in at least one location from the protrusion and the recess.

6. The gas storage container according to claim 1,
further comprising a gas remaining amount measurement module.

7. The gas storage container according to claim 6, wherein
at least a part of the gas remaining amount measurement module is installed in a space between the casing and the gas container.

8. The gas storage container according to claim 7, wherein
at least a part of the gas remaining amount measuring module is installed so as not to be visible through the window.

9. The gas storage container according to claim 1,
further comprising a porous material in the gas container.

10. (canceled)

11. The gas storage container according to claim 4, wherein
wherein the window is provided in at least one location selecting from the protrusion and the recess.

12. The gas storage container according to claim 2, wherein
one of the upper surface and the lower surface is provided with a protrusion, and the other of the upper surface and the lower surface is provided with a recess corresponding to the protrusion.

13. The gas storage container according to claim 2, wherein
the casing has a plurality of side surfaces, and at least one of the side surfaces is provided with a protrusion, and the other side surface opposite to the at least one of the side surfaces is provided with a recess corresponding to the protrusion.

14. The gas storage container according to claim 12, wherein
wherein the window is provided in at least one location selecting from the protrusion and the recess.

15. The gas storage container according to claim 2, wherein
further comprising a gas remaining amount measurement module.

16. The gas storage container according to claim 15, wherein
at least a part of the gas remaining amount measurement module is installed in a space between the casing and the gas container.

17. The gas storage container according to claim 16, wherein
at least a part of the gas remaining amount measuring module is installed so as not to be visible through the window.

18. The gas storage container according to claim 2, wherein
further comprising a porous material in the gas container.

19. The gas storage container according to claim 13, wherein
wherein the window is provided in at least one location selecting from the protrusion and the recess.

20. The gas storage container according to claim 1, wherein
one of the upper surface and the lower surface is provided with a first protrusion, and the other of the upper surface and the lower surface is provided with a first recess corresponding to the first protrusion, and
the casing has a plurality of side surfaces, and at least one of the side surfaces is provided with a second protrusion, and the other side surface opposite to the at least one of the side surfaces is provided with a second recess corresponding to the second protrusion.

21. The gas storage container according to claim 20, wherein
wherein the window is provided in at least one location selecting from the first protrusion, the first recess, the second protrusion, and the second recess.
